(19) United States
(12) Patent Application Publication
(10) Pub. No.: US 2008/0124269 A1
(43) Pub. Date: May 29, 2008

(54) PURIFIED MOLYBDENUM TECHNICAL OXIDE FROM MOLYBDENITE

(75) Inventors: PIETER JOHANNES DAUDEY, Alphen Aan Den Rijn (NL); Harmannus Willem Homan Free, Hoevelaken (NL); Bas Tappel, Amsterdam (NL); Parmanand Badloe, Nieuwegein (NL); Johan Van Oene, Zandvoort (NL); Christopher Samuel Knight, Prairieville, LA (US); Thanikavelu Manimaran, Baton Rouge, LA (US)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., AMERSFOORT (NL)

(21) Appl. No.: 11/941,717

(22) Filed: Nov. 16, 2007

Related U.S. Application Data
(60) Provisional application No. 60/859,560, filed on Nov. 16, 2006.

(51) Int. Cl. C01G 39/02

(52) U.S. Cl. 423/606

(57) ABSTRACT

A process for converting molybdenum technical oxide, partially oxidized MoS₂ or off-spec products from MoS₂ oxidation processes into a purified molybdenum trioxide product is provided, generally comprising the steps of: combining molybdenum technical oxide with an oxidizing agent and a leaching agent in a reactor under suitable conditions to effectuate the oxidation of residual MoS₂, MoO₂ and other oxidizable molybdenum oxide species to MoO₃, as well as the leaching of any metal oxide impurities; precipitating the MoO₃ species in a suitable crystal form; filtering and drying the crystallized MoO₃ product; and recovering and recycling any solubilized molybdenum.

Molybdenum is principally found in the earth's crust in the form of molybdenite (MoS₂) distributed as very fine veinlets in quartz which is present in an ore body comprised predominantly of altered and highly silicified granite. The concentration of the molybdenite in such ore bodies is relatively low, typically about 0.05 wt % to about 0.1 wt %. The molybdenite is present in the form of relatively soft, hexagonal, black flaky crystals which are extracted from the ore body and concentrated by any one of a variety of known processes so as to increase the molybdenum disulfide content to a level of usually greater than about 80 wt % of the concentrate. The resultant concentrate is subjected to an oxidation step, which usually is performed by a roasting operation in the presence of air, whereby the molybdenum disulfide is converted to molybdenum oxide.

The molybdenite concentrate may be produced by any one of a variety of ore beneficiation processes in which the molybdenite constituent in the ore body is concentrated so as to reduce the gangue to a level less than about 40%, and more usually to a level of less than about 20%. A common method of producing the molybdenite concentrate comprises subjecting the molybdenite containing ore to a grinding operation, whereby the ore is reduced to particles of an average size usually less than about 100 mesh, and whereafter the pulverized ore is subjected to an oil flotation extraction operation employing hydrocarbon oils in combination with various wetting agents, whereby the particles composed predominantly of molybdenum disulfide are retained in the flotation froth, while the gangue constituents composed predominantly of silica remain in the tailing portion of the pulp. The flotation beneficiation process normally involves a series of successive flotation extraction operations, each including an intervening grinding operation, whereby the residual gangue constituents in the concentrate are progressively reduced to the desired level. Technical grade molybdenite concentrates commercially produced by the oil flotation beneficiation process usually contain less than about 10% gangue, and more usually from about 5% to about 6% gangue, with the balance consisting essentially of molybdenum disulfide.

The molybdenite concentrate is next subjected to an oxidation step to effect a conversion of the molybdenum sulfide constituent to molybdenum oxide. Perhaps the most common oxidation technique employed comprises roasting the concentrate in the presence of excess air at elevated temperatures ranging from about 500° C. up to a temperature below that at which molybdenum oxide melts. The roasting operation, which proceeds generally according to the following chemical reactions,

2MoS₂+7O₂→2MoO₃+4SO₂

MoS₂+6MoO₃→7MoO₂+2SO₂

2MoO₂+O₂→2MoO₃

may utilize a multiple-hearth furnace incorporating a plurality of annular-shaped hearths disposed in vertically spaced relationship, on which the molybdenite concentrate is transferred and passes in a cascading fashion downwardly from the uppermost hearth to the lowermost hearth while being exposed to a countercurrent flow of hot flue gases. Typical of roasting apparatuses of the foregoing type are those commercially available under the designation Herreshoff, McDougall, Wedge, Nichols, etc.

The resultant roasted concentrate consists predominantly of molybdenum oxide, of which the major proportion thereof is in the form of molybdenum trioxide. When the feed material is of a particle size generally greater than about 200 mesh, or wherein some agglomeration of the particles has occurred during the roasting operation, it is usually preferred to subject the roasted concentrate to a supplemental grinding or pulverizing step, such as a ball milling operation, whereby any agglomerates present are eliminated, and wherein the concentrate is reduced to an average particle size of less than 200 mesh, and preferably, less than about 100 mesh.

Besides roasting operations, isolated MoS₂ may be converted into molybdenum oxide reaction products (primarily MoO₃) by a variety of oxidization methods, such as high pressure wet oxidization processes (i.e., autoclaving), such as those discussed in U.S. Pat. Nos. 4,379,127 and 4,512,958, both to Bauer, et al.

For example, U.S. Pat. Nos. 4,379,127 and 4,512,958 each involve a procedure in which MoS₂ is converted (oxidized) into MoO₃ by forming a slurry or suspension of MoS₂ in water and thereafter heating the slurry in an autoclave. During the heating process, an oxygen atmosphere is maintained within the autoclave.

Both of these references also discuss the recycling of various reaction products back to the initial stages of the procedure in order to adjust the density of the slurry so that proper temperature levels are maintained within the system. In U.S. Pat. No. 4,512,958, the autoclave temperature is controlled by constantly adjusting the suspension density (e.g., the ratio of water to solids). Higher density values will result in temperature increases within the autoclave. Likewise, if lower temperatures are desired, fluids can be added to reduce the suspension density.

In the process described in the '958 patent, water and MoS₂ are combined in a slurrying unit to generate a suspension which is then routed to the autoclave. Oxygen is subsequently added to the contents of the autoclave to produce an oxidized suspension, which is thereafter filtered to generate a solid product and a first filtrate. The first filtrate, which contains substantial amounts of sulfuric acid, is subsequently treated in a precipitation reactor where it is neutralized by the addition of limestone (calcium carbonate). As a result, a suspension of calcium sulfate dihydrate (e.g., gypsum) is produced which is filtered to generate a solid gypsum product and a second filtrate. The autoclave may include a controller and associated sensor to facilitate the operation of a series of valves to control the amount of water added to the suspension within the autoclave and the amount of oxygen supplied to the autoclave. Selective water addition in this manner controls the temperature levels in the suspension. When lower temperature levels are desired, more water is added and vice versa.

The '127 patent is closely related to the '958 patent just described and discloses a method for recovering molybdenum oxide in which the suspension density and temperature are maintained at desired levels. Specifically, the levels include a density of 100-150 g of solids per liter and a temperature of 230-245° C.

U.S. Pat. No. 3,656,888 to Barry et al., discloses a process in which MoS₂ starting materials are combined with water in an autoclave to produce a slurry. Pure oxygen, air, or a mixture of both is thereafter added to the autoclave in order to oxidize the MoS₂. The resulting product is then delivered to a first filter so that MoO₃ can be separated from the liquid filtrate. The liquid filtrate is then routed to a neutralizer in which an alkaline compound is added in order to precipitate dissolved MoO₃. The resulting MoO₃ is thereafter collected in a second filter. Next, the filter cake obtained from the first filter (which contains unreacted MoS₂) is washed with ammonium hydroxide in order to dissolve the MoO₃ and leave the MoS₂ unaffected. The undissolved materials are thereafter collected using a third filter.

The collected MoS₂ is then charged to a second autoclave in which the MoS2 is combined with water to form a slurry. The slurry is thereafter oxidized as discussed above with an oxygen-containing gas. The oxidized slurry is subsequently filtered in a fourth filter to collect the resulting solid MoO₃. The liquid filtrate is transferred to a neutralizer. The filter cake obtained from the fourth filter is washed with aqueous ammonium hydroxide which again dissolves the MoO₃ (to produce ammonium molybdate) while leaving the residual contaminants (e.g., unreacted MoS₂) undissolved. The undissolved contaminants are collected using a fifth filter and are thereafter discarded. The liquid filtrate from the fifth filter is mixed with the filtrate obtained from the third filter and treated by evaporation or crystallization, followed by calcination to generate purified MoO₃.

U.S. Pat. No. 3,714,325 to Bloom et al., involves a procedure in which molybdenite which contains Fe and Cu impurities is combined with water to form a slurry. The slurry is then heated to about 100-150° C. in an oxygen atmosphere at a pressure of about 200-600 psi for 30-60 minutes. After this step, the aqueous slurry is removed from the reaction vessel and filtered to separate the solid residue from the leach liquor. The residue consists primarily of MoS₂ (about 80-90% by weight), with the liquor containing the aforementioned metallic impurities (e.g., Cu and Fe).

In U.S. Pat. No. 4,724,128 to Cheresnowsky, et al., a method is described wherein MoO₃, ammonium dimolybdate, or ammonium paramolybdate is roasted to produce MoO₂ (molybdenum dioxide). To remove potassium contaminants from the MoO₂, this material is washed with water to generate a slurry. The resulting wash water which contains the potassium contaminants is then removed from the system.

U.S. Pat. No. 4,553,749 to McHugh, et al., discloses a procedure in which MoS₂ is converted directly to MoO₂ by combining the MoS₂ with MoO₃ vapor. The MoO₃ vapor is preferably produced by routing a portion of the previously-generated MoO₂ into a flash furnace where it is subjected to “flash sublimation” in order to oxidize the MoO₂. As a result, a supply of MoO₃ vapor is created which can be used to treat the initial supplies of MoS₂ as discussed above.

Oxidation of Molybdenite by Water Vapor, Blanco et al., Sohn Internatioanl Symposium Advanced Processing of Metals and Materials, Vol. I, 2006, discloses a process for converting MoS₂ into MoO₂ by contacting the molybdenite with water vapor at temperatures between 700 and 1100° C. The off-gases form a mixture of SO₂, H₂S, H₂ and H₂O.

U.S. Pat. No. 3,834,894 to Spedden, et al., involves a detailed process for purifying MoS₂ using a diverse sequence of heating and flotation steps to yield a high-grade MoS₂ concentrate.

Notwithstanding the processes described above, a need remains for a highly efficient method in which a purified MoO₃ product is produced from MoS₂ which focuses on the efficiency of wet chemistry. The processes discussed above may be operated such that only a partial oxidation of MoS₂ to molybdenum oxides occurs. Alternatively, off-spec products may be derived from these processes. In these instances, wet chemistry may be employed to convert the partially oxidized MoS₂, or off-spec product, to a purified molybdenum trioxide product.

It is desirable or necessary in some instances to provide a molybdenum trioxide (MoO₃) product that is relatively free of metallic contaminants, as well as possessing a low concentration of molybdenum dioxide (MoO₂), or other molybdenum oxide species with a valency lower than +6, such as, for example, Mo₄O₁₁, which, for the sake of simplicity herein, will also be referred to as MoO₂. This high purity material may be used for the preparation of various molybdenum compounds, catalysts, chemical reagents or the like. As used herein, the term molybdenum technical oxide means any material comprising anywhere from about 1 wt % to about 99 wt % MoO₂, and may optionally further comprise MoS₂ or other sulfidic molybdenum, iron, copper, or lead species. The production of high purity MoO₃ has previously been achieved by various chemical and physical refining techniques, such as the sublimation of the technical oxide at an elevated temperature, calcination of crystallized ammonium dimolybdate, or various leaching or wet chemical oxidation techniques. However, these processes may be expensive and often result in low yields and/or ineffective removal of contaminants.

One embodiment of the present invention provides a process for converting molybdenum technical oxide, partially oxidized MoS₂ concentrate, or an off-spec product from a MoS₂ oxidizing process into a purified molybdenum trioxide product. Generally, the process comprises the steps of: combining molybdenum technical oxide, partially oxidized MoS₂ concentrate, or an off-spec product from a MoS₂ oxidizing process with an oxidizing agent and a leaching agent in a reactor under suitable conditions to effectuate the oxidation of residual MoS₂, MoO₂ and other oxidizable molybdenum oxide species to MoO₃, as well as the leaching of any metal oxide impurities; precipitating the MoO₃ species in a suitable crystal form; filtering and drying the crystallized MoO₃ product; and recovering and recycling any solubilized molybdenum. Depending on process conditions, the solid product may be precipitated as crystalline or semi-crystalline H₂MoO₄, H₂MoO₄.H₂O, MoO₃ or other polymorphs or pseudo-polymorphs. The reaction may be performed as a batch, semi-continuous, or continuous process. Reaction conditions may be chosen to minimize the solubility of MoO₃ and to maximize the crystallization yield. Optionally, seeding with the desired crystal form may be utilized. The filtrate may be recycled to the reactor to minimize MoO₃ losses, as well as oxidizing agent and leaching agent consumption. A portion of the filtrate may be purged to a recovery process wherein various techniques may be employed, such as precipitation of molybdic acid with lime or calcium carbonate to form CaMoO₄, precipitation as Fe₂(MoO₄)₃.xH2O and other precipitations, depending on chemical composition. Likewise, ion exchange or extraction may be employed, for example, anion exchange employing caustic soda regeneration to obtain a sodium molybdate solution that is recycled to the reaction step and crystallized to MoO₃. Metal oxide impurities may also be separately treated, e.g., by ion exchange, for recovery and/or to be neutralized, filtered and discarded.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 shows a block flow diagram of the process of the present invention.

FIG. 2 shows the dissolution of MoO₃ in HNO₃.

FIG. 3 shows the variability of leaching metal impurities with HNO₃.

FIG. 4 shows the oxidation of MoO₂ in H₂SO₄ (fixed)/HNO₃ (variable) solutions.

FIG. 5 shows the dissolution of MoO₃ in H₂SO₄ (fixed)/HNO₃ (variable) solutions.

FIG. 6 shows the dissolution of MoO₃ in H₂SO₄ (variable)/HNO₃ (fixed) solutions.

FIG. 7 shows the variability of leaching metal impurities with H₂SO₄ (variable)/HNO₃ (fixed) solutions.

FIG. 8 shows the oxidation of MoO₂ in H₂SO₄ (variable)/HNO₃ (fixed) solutions

FIG. 9 shows the oxidation of MoO₂ in H₂SO₄/H₂O₂ solutions.

FIG. 10 shows the oxidation of MoO₂ in H₂SO₄/KMnO₄ or KS₂O₈ solutions.

FIG. 11 shows the oxidation of MoO₂ in Caro's acid solutions.

### DESCRIPTION OF THE INVENTION

### Technical Oxide:

Technical oxides suitable for use in the present invention are available from several commercial sources. Table 1 below provides a few non-limiting examples of technical oxides suitable for use with the processes described herein. It should be noted that besides technical oxides similar to those presented, molybdenum disulfide could also be employed as a raw material. The following elemental analysis was conducted using sequential X-ray Fluorescence Spectrometry (XRF) and Inductively Coupled Plasma (ICP) Spectrometry. For the ICP analyses, samples were dissolved in aqueous ammonia wherein the MoO₃ dissolved and insolubles were filtered. The molybdenum from the ammonium dimolybdate solution is labeled as MoO₃ in the table and the molybdenum from the insolubles is denoted MoO₂.

TABLE 1

| | Sample 1 | | Sample 2 | | Sample 3 | |
|---|---|---|---|---|---|---|
| | XRF | ICP | XRF | ICP | XRF | ICP |
| MoO₂ | | 31.7 | | 3.6 | | 9.5 |
| MoO₃ | 87.4 | 60.5 | 87.3 | 90.2 | 92.2 | 79.6 |
| CuO (mg/kg) | 2000 | 1600 | 600 | 500 | 3000 | 3200 |
| PbO (mg/kg) | | | 500 | | | |
| CaO (mg/kg) | 6000 | 8300 | 600 | 300 | 2000 | 2300 |
| Na (mg/kg) | | | 500 | | | |
| S (mg/kg) | | | 500 | | | |
| TiO₂ % | 0.1 | | | | | |
| Al₂O₃ % | 0.7 | | 0.51 | 0.67 | | 0.35 |
| K₂O % | 0.4 | 0.33 | | 0.18 | 0.2 | 0.13 |
| SiO₂ % | 6.1 | | 4.9 | 4 | 5 | 7.4 |
| Fe % | 2.31 | 2.45 | 0.14 | 0.12 | 0.56 | 0.59 |
| Na₂O % | | 0.06 | | | | |
| MgO % | 0.2 | 0.27 | | | | |

As described above, in addition to technical oxide, molybdenum sulfide raw materials, such as partially oxidized MoS₂ or off-spec products from MoS₂ oxidation processes may be utilized with the present invention.

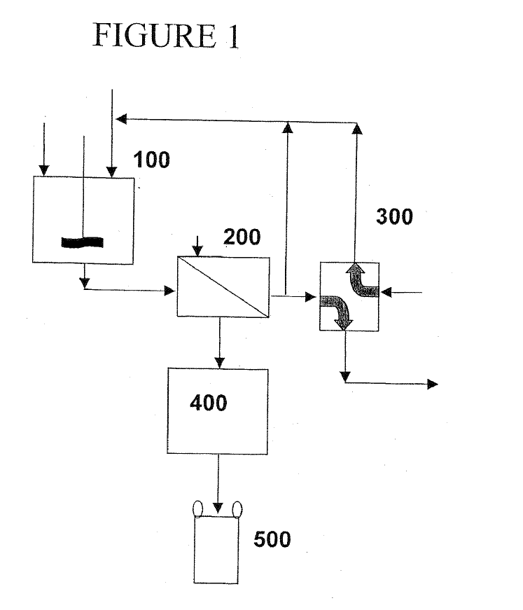

Referring now to FIG. 1, the technical oxide and/or molybdenum sulfide raw materials are introduced into a reaction vessel (100), preferably a jacketed, continuously—stirred tank reactor, but any suitable reaction vessel may be employed. The raw material is mixed in the reaction vessel (100) with a leaching agent, to dissolve metal impurities, and an oxidizing agent, to oxidize MoS₂ and MoO₂ to MoO₃.

While any common lixiviant, or mixtures of common lixiviants, may be employed, sulfuric acid and hydrochloric acid are preferred leaching agents. Similarly, while any common oxidizing agent, or mixtures of common oxidizing agents, may be employed, including but not limited to hypochlorite, ozone, oxygen-alkali, acid permanganate, persulfate, acid-ferric chloride, nitric acid, chlorine, bromine, acid-chlorate, manganese dioxide-sulfuric acid, hydrogen peroxide, Caro's acid, or bacterial oxidation, Caro's acid and chlorine are the preferred oxidizing agents.

The leaching agent and oxidizing agent may be added in any order, or may be added together such that the leaching and oxidation occur simultaneously. In some instances, such as when using Caro's acid, leaching and oxidation occur by the action of the same reagent. In other instances, the leaching agent may be formed in situ by the addition of an oxidizing agent, for example, the addition of chlorine or bromine to the reaction mass results in the formation of hydrochloric or hydrobromic acid. The reaction mass is agitated in the reaction vessel (100) for a suitable time and under suitable process conditions to effectuate the oxidation of residual MoS₂, MoO₂ and other oxidizable molybdenum oxide species to MoO₃, and to leach any metal oxide impurities, say for example between about 15 minutes to about 24 hours at a temperature ranging from about 30° C. to about 150° C. Depending on the particular oxidizing agent employed, the reaction pressure may range from about 1 bar to about 6 bar. Depending on the lixiviant employed, the pH of the reaction mass may range from about −1 to about 3. Whereas the lixiviant and oxidizer may act separately when dosed one after another, it has been observed that simultaneous action of lixiviant and oxidizer is beneficial for driving both the oxidation and leaching reactions to completeness.

While leaching of impurities and oxidization of MoS₂ and MoO₂ occurs, the majority of the MoO₃ precipitates, or crystallizes, from the solution. However, a portion of the MoO₃ formed by oxidation or dissolved from MoO₃ in the starting material may remain in solution for various reasons. While not intending to be bound by theory, it is generally believed that wet-chemical oxidation in a slurry process is mechanistically explained by either oxidative dissolution of species at the solid-liquid interface, or by dissolution, perhaps slow dissolution, of the oxidizable species followed by oxidation in the liquid phase. The most probable form of Mo⁶⁺ species in solution, denoted as dissolved MoO₃, is believed to be H₂MoO₄, but a variety of other species are also possible. It has been observed that when the oxidation is not complete, blue colored solutions with a high amount of dissolved molybdenum oxide species result, the blue color pointing at polynuclear mixed Mo⁶⁺/Mo⁶⁺ oxidic species.

Also, crystallization is a slow process at low temperatures, so the crystallization conditions chosen may result in a lower or higher amount of dissolved molybdenum oxide species. Thus, after the precipitated trioxide, together with hitherto undissolved MoO3 or other species from the starting technical oxide is removed by filtration (200), the filtrate can be recycled to the reaction vessel (100). Because the leached metal impurities will also be recycled to the reaction vessel (100), a slipstream of the recycled material may be drawn off and treated for removal or recovery of the metal impurities. The filter cake (MoO₃ product) may be dried (400) and packed for distribution (500).

In order to recover any molybdenum in the slipstream, it may be treated in a suitable ion-exchange bed (300). One preferred ion-exchange bed comprises a weakly basic anion exchange resin (cross-linked polystyrene backbone with N,N′-di-methyl-benzylamine functional groups), preloaded with sulfate or chloride anions, wherein molybdate ions are exchanged with sulfate or ions chloride ions during resin loading and the resin is unloaded with dilute sodium hydroxide, about 1.0 to 2.5 M. The unloaded molybdenum is recovered by recycling the dilute sodium molybdate (Na₂MoO₄) stream (regenerant) to the reaction vessel (100).

Following recovery of molybdenum, the slipstream may be subsequently treated in additional ion-exchange beds (600) in order to remove additional metallic species. Any remaining metal impurities will be precipitated (700) and filtered (800) for final disposal. After these treatment steps a residual solution is obtained containing mainly dissolved salts like NaCl or Na₂SO₄, depending on the chemicals selected that may be purged.

### EXAMPLES

It should be noted that within the following discussion several stoichiometric schemes are discussed. While not desiring to be bound by any theory, the inventors herein believe that the disclosed schemes accurately describe the discussed mechanisms.

75 grams of technical oxide was mixed with 250 ml of various acidic solutions listed and described below. The mixtures were stirred with a Teflon coated magnetic stirrer and heated to 70° C. for two hours. The mixtures were cooled to room temperature and filtered over a 90 mm black ribbon filter. The filter cake was washed with 20 ml of deionized water. The filtrate was brought to 250 ml volume and the filter cake was dried overnight at 120° C. The dried filter cake was analyzed for content, as well as metal impurities. The filtrate was analyzed for metal impurities.

### Nitric Acid:

The leaching of the technical oxide (TO) and calcined technical oxide (TOC) was performed in a series of acid solutions from 0.1 to 10 N HNO₃. Leaching and oxidation occurs by action of the single reagent. The oxidation stoichiometry can be summarized as follows:

MoO₂+2H⁺+2(NO₃)⁻→MoO₃+2NO₂(g)↑+H₂O

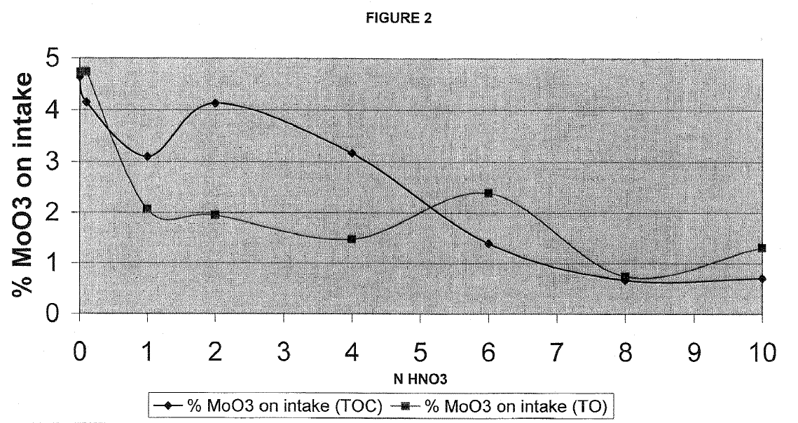

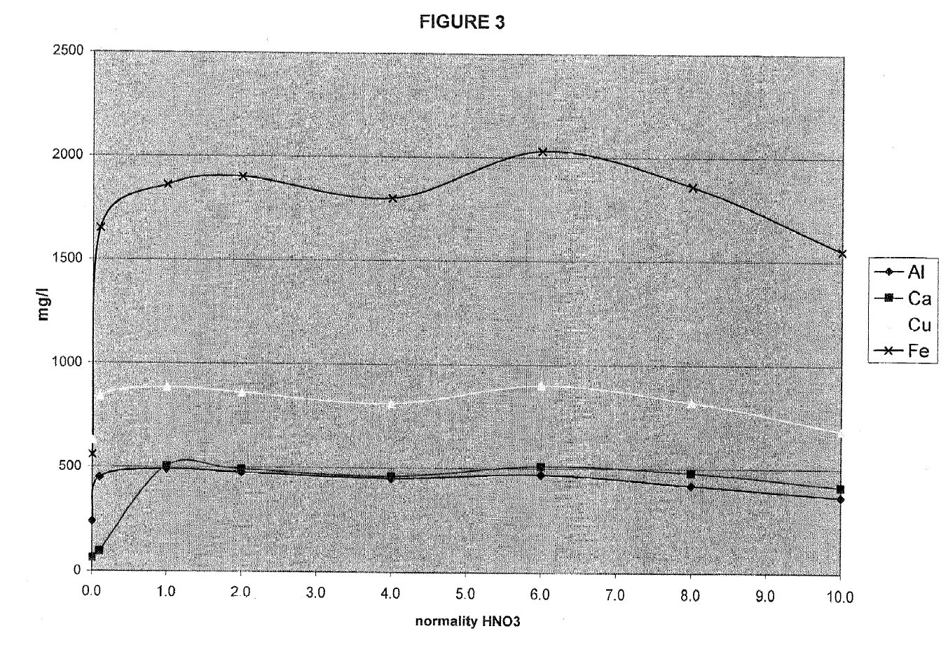

MoO₂ in the sample was completely converted to MoO₃ with nitric acid. A color change was also visible form dark blue (Mo⁵⁺) to grass green/blue green. The solubility of MoO₃ decreases with acid concentration as shown in FIG. 2. Cu and Fe dissolve readily in low concentrations of nitric acid. Some metals (Ba, Pb, Sr, and Ca) needed more the 1 N nitric acid to dissolve as shown in FIG. 3 and Table 2. Brown NO₂ fumes were visible with excess HNO₃. The results of the leaching/oxidation of technical oxide with nitric acid are summarized in Table 2.

TABLE 2

| | | | | | | EX E. | EX. F | EX. G |
|---|---|---|---|---|---|---|---|---|
| | | EX. A | EX. B | EX. C | EX. D | Calcined | Calcined | Calcined |
| Intake | intake g | 75 | 75 | 75 | 75 | 75 | 75 | 75 |
| | liquid ml | 250 | 250 | 250 | 250 | 250 | 250 | 250 |
| | N HNO3 | 4 | 6 | 8 | 10 | 0 | 0.1 | 1 |
| | solids % | 22.50 | 22.50 | 22.50 | 22.50 | 22.50 | 22.50 | 22.50 |
| | leaching temp ° C. | 70 | 70 | 70 | 70 | 70.00 | 70.00 | 70.00 |
| | leaching time hrs | 2 | 2 | 2 | 2 | 2.00 | 2.00 | 2.00 |
| filtercake 500° C. XRF | % SiO2 | 4.00 | 4.20 | 3.50 | 4.00 | 6.80 | 4.30 | 3.90 |
| method Uniquant | % K2O | <0.1 | <0.1 | <0.1 | <0.1 | <0.1 | 0.10 | |
| | % CaO | <0.1 | <0.1 | <0.1 | <0.1 | 0.20 | 0.20 | 0.1 |
| | % Fe2O3 | <0.1 | <0.1 | <0.1 | <0.1 | 0.70 | 0.10 | <0.1 |
| | % MoO3 | 94.30 | 94.40 | 94.40 | 94.40 | 91.90 | 93.50 | 94.20 |
| | % CdO | <0.1 | <0.1 | <0.1 | <0.1 | | | |
| | % ThO2 | <0.1 | <0.1 | <0.1 | <0.1 | | | |
| filtercake 120° C. | % MoO2 | 0.23 | 0.19 | 0.13 | 0.16 | | | |
| | % MoO3 | 89.56 | 89.70 | 90.90 | 91.89 | | | |
| filtrate ICP analyses | Al | 330 | 315 | 341 | 314 | 240 | 450 | 490 |
| mg/l | Ca | 400 | 360 | 430 | 380 | 65 | 95 | 505 |
| | Mg | 35 | 32 | 37 | 34 | 25 | 40 | 45 |
| | Na | 29 | 25 | 33 | 22 | 40 | 35 | 50 |
| | P | 26 | 19 | 27 | 13 | 30 | 35 | 35 |
| | S | 62 | 75 | 80 | 65 | 45 | 50 | 65 |
| | Sr | 22 | 23 | 23 | 19 | 5 | 10 | 25 |
| | Cu | 673 | 630 | 710 | 630 | 630 | 840 | 885 |
| | Fe | 1477 | 1406 | 1611 | 1425 | 560 | 1650 | 1860 |
| | Mo | 2942 | 4770 | 1480 | 2610 | 9260 | 8300 | 6190 |
| | Pb | 29 | 46 | 58 | 49 | <5 | <5 | <5 |
| | Ti | 7 | 13 | 9 | 5 | 20 | 10 | 25 |
| | Zn | 17 | 17 | 18 | 15 | 15 | 20 | 20 |
| | K | 400 | 375 | 330 | 235 | 160 | 70 | 190 |
| | Ag | | | | | <5 | <5 | <5 |
| | Ba | | | | | 3 | 2 | 11 |

| | | EX. H | EX. I | EX. J | EX. K | EX. L |
|---|---|---|---|---|---|---|
| | | Calcined | Calcined | Calcined | Calcined | Calcined |
| Intake | intake g | 75 | 75 | 75 | 75 | 75 |
| | liquid ml | 250 | 250 | 250 | 250 | 250 |
| | N HNO3 | 2 | 4 | 6 | 8 | 10 |
| | solids % | 22.50 | 22.50 | 22.50 | 22.50 | 22.50 |
| | leaching temp ° C. | 70.00 | 70.00 | 70.00 | 70.00 | 70.00 |
| | leaching time hrs | 2.00 | 2.00 | 2.00 | 2.00 | 2.00 |
| filtercake 500° C. XRF | % SiO2 | 4.50 | 5.30 | 4.00 | 4.30 | 4.40 |
| method Uniquant | % K2O | | | | <0.1 | <0.1 |
| | % CaO | <0.1 | <0.1 | | <0.1 | <0.1 |
| | % Fe2O3 | <0.1 | <0.1 | <0.1 | <0.1 | <0.1 |
| | % MoO3 | 94.50 | 92.90 | 94.30 | 94.10 | |
| | % CdO | | | | <0.1 | <0.1 |
| | % ThO2 | | | | <0.1 | <0.1 |
| filtercake 120° C. | % MoO2 | | | | | <0.5 |
| | % MoO3 | | | | | 91.00 |
| filtrate ICP analyses | Al | 475 | 450 | 470 | 420 | 365 |
| mg/l | Ca | 490 | 460 | 510 | 480 | 415 |
| | Mg | 40 | 40 | 45 | 40 | 35 |
| | Na | 45 | 45 | 50 | 45 | 40 |
| | P | 35 | 35 | 40 | 40 | 30 |
| | S | 60 | 60 | 70 | 66 | 55 |
| | Sr | 25 | 25 | 26 | 25 | 20 |
| | Cu | 860 | 810 | 900 | 820 | 685 |
| | Fe | 1900 | 1800 | 2030 | 1860 | 1550 |
| | Mo | 8260 | 6330 | 2780 | 1325 | 1400 |
| | Pb | 29 | 33 | 68 | 62 | 54 |
| | Ti | 25 | 20 | 40 | 15 | 15 |
| | Zn | 20 | 20 | 20 | 20 | 15 |
| | K | 190 | 180 | 230 | 210 | 180 |
| | Ag | 8 | 7 | 7 | 6 | 7 |
| | Ba | 14 | 10 | 14 | 12 | 10 |

### Sulfuric Acid/Nitric Acid:

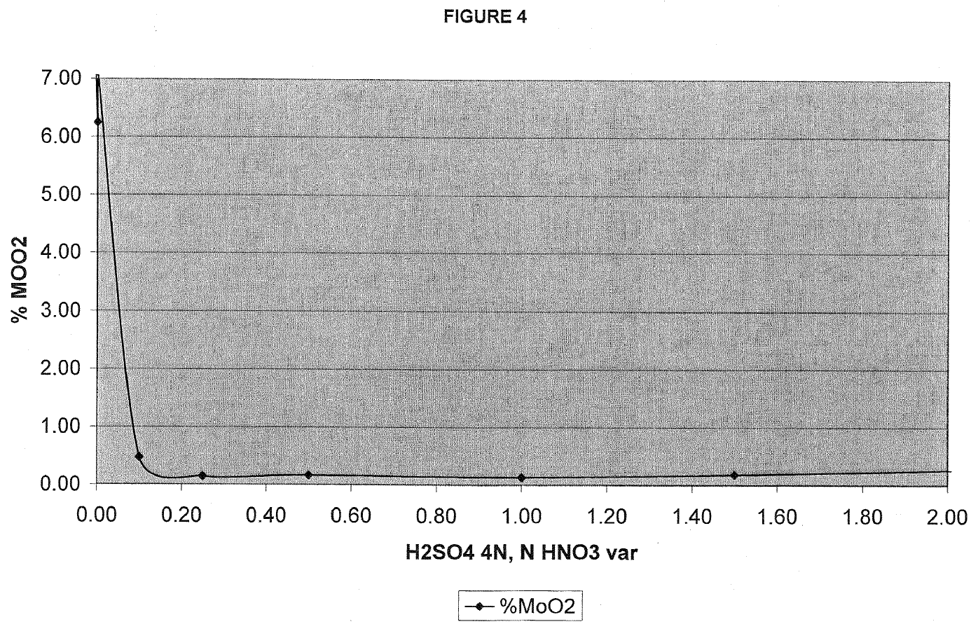

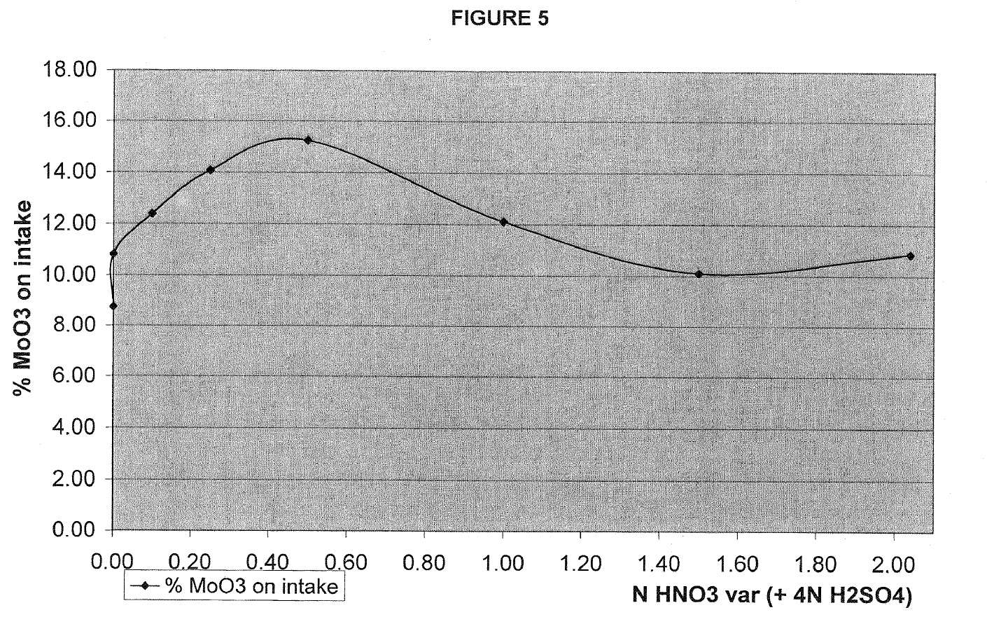

Keeping the concentration of H₂SO₄ fixed at 4N and varying the concentration of HNO₃ from 0 to 2 N in six increments, a series of acidic solutions were prepared. Technical oxide was mixed in each of the solutions and the results of the leaching/oxidation with H₂SO₄/HNO₃ mixtures are summarized in Table 3. Brown NO₂ fumes were visible with excess HNO₃. The color of the solution changed from dark blue to light grass green. The oxidation was almost complete starting from 0.2 N HNO₃. See FIG. 4. The dissolution of MoO₃ in varying concentrations of the acidic solution is shown in FIG. 5. Ca, Fe and Cu dissolve well, but Pb did not dissolve.

TABLE 3

| | | EX. 2A | EX. 2B | EX. 2C | EX. 2D | EX. 2E | EX. 2F | EX. 2G | EX. 2H |
|---|---|---|---|---|---|---|---|---|---|
| Intake | intake g | 75 | 75 | 75 | 75 | 75 | 75 | 75 | 75 |
| | liquid ml | 250 | 250 | 250 | 250 | 250 | 250 | 250 | 250 |
| | N H2SO4 | 4N | 4N | 4N | 4N | 4N | 4N | 4N | 4N |
| | ml H2SO4 96% | 28 | 28 | 28 | 28 | 28 | 28 | 28 | 28 |
| | N HNO3 | 0.00 | 0.10 | 0.25 | 0.50 | 1.00 | 1.50 | 2.00 | 0.00 |
| | ml HNO3 65% | 0.00 | 1.74 | 5.22 | 8.70 | 17.66 | 26.16 | 34.67 | 0.00 |
| | solids % | 22.50 | 22.50 | 22.50 | 22.50 | 22.50 | 22.50 | 22.50 | 22.50 |
| | leaching temp ° C. | 70 | 70 | 70 | 70 | 70 | 70 | 70 | 70 |
| | leaching time hrs | 2 | 2 | 2 | 2 | 2 | 2 | 2 | 2 |
| filtercake 500° C. | % MgO | | | | | | | | |
| XRF method | % SiO2 | 7.40 | 7.40 | 7.30 | 7.90 | 7.10 | 6.90 | 7.00 | 7.40 |
| Uniquant | % K2O | 0.10 | 0.10 | 0.10 | 0.10 | <0.1 | 0.10 | 0.10 | 0.10 |
| | % CaO | | | | | | | | |
| | % Fe2O3 | 0.10 | 0.10 | <0.1 | <0.1 | <0.1 | <0.1 | <0.1 | 0.1 |
| | % MoO3 | 91.90 | 92.10 | 92.20 | 91.60 | 92.70 | 92.70 | 92.60 | 92.20 |
| | % CdO | | | | | | | | |
| | % ThO2 | | | | | | | | |
| | % CuO | | | | | | | | |
| | % PbO | | | | | | | | |
| | % Na2O | | | | | | | | |
| | % SO4 | 0.20 | | | | | | | |
| filtercake 120° C. | % MoO2 | 6.25 | 0.47 | 0.14 | 0.16 | 0.13 | 0.18 | 0.12 | 7.11 |
| | % MoO3 | 81.56 | 85.44 | 89.18 | 89.01 | 88.47 | 89.12 | 89.28 | 82.80 |
| filtrate ICP | Ag | <5 | <5 | <5 | <5 | <5 | <5 | <5 | <5 |
| analyses mg/l | Al | 407 | 452 | 405 | 384 | 413 | 418 | 422 | 405 |
| | Ba | <1 | <1 | <1 | <1 | <1 | <1 | <1 | <1 |
| | Ca | 475 | 527 | 472 | 445 | 466 | 479 | 483 | 470 |
| | Mg | 42 | 46 | 40 | 37 | 40 | 42 | 41 | 40 |
| | Na | 38 | 42 | 36 | 34 | 35 | 37 | 38 | 36 |
| | P | <50 | <50 | <50 | <50 | <50 | <50 | <50 | <50 |
| | S | 58000 | 65130 | 59420 | 55870 | 59380 | 59320 | 59520 | 59360 |
| | Sr | 19 | 22 | 20 | 18 | 20 | 21 | 20 | 18 |
| | Cu | 759 | 837 | 747 | 719 | 759 | 770 | 782 | 747 |
| | Fe | 1660 | 1877 | 1671 | 1596 | 1705 | 1735 | 1747 | 1634 |
| | Mo | 17500 | 24760 | 28120 | 30460 | 24220 | 20220 | 21720 | 21630 |
| | Pb | <10 | <10 | <10 | <10 | <10 | <10 | <10 | <10 |
| | Ti | 27 | 24 | 24 | 25 | 23 | 21 | 22 | 28 |
| | Zn | 17 | 19 | 18 | 17 | 17 | 18 | 18 | 17 |
| | K | 162 | 173 | 141 | 140 | 161 | 167 | 189 | 173 |

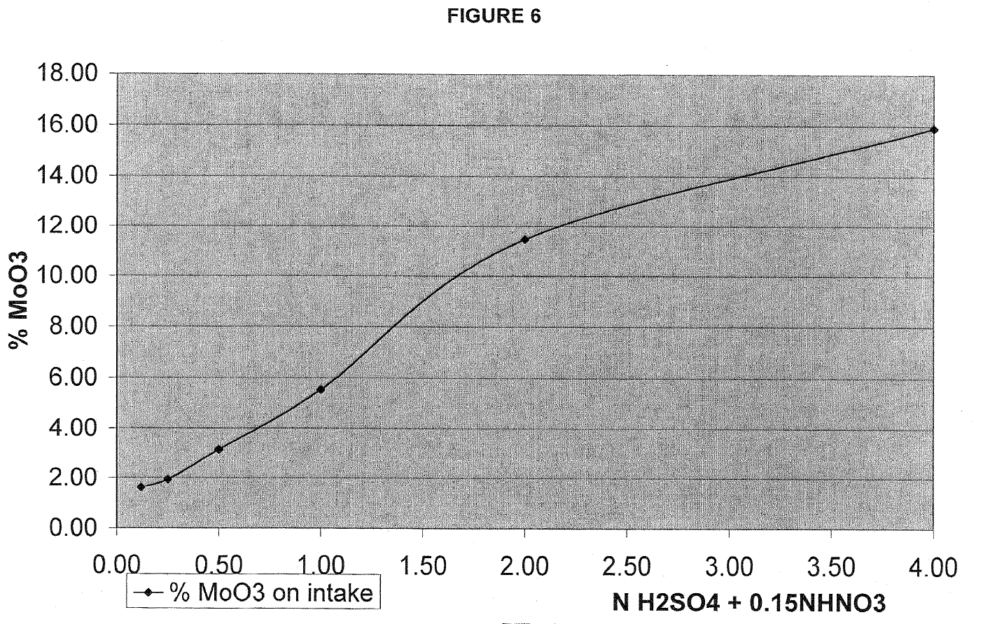

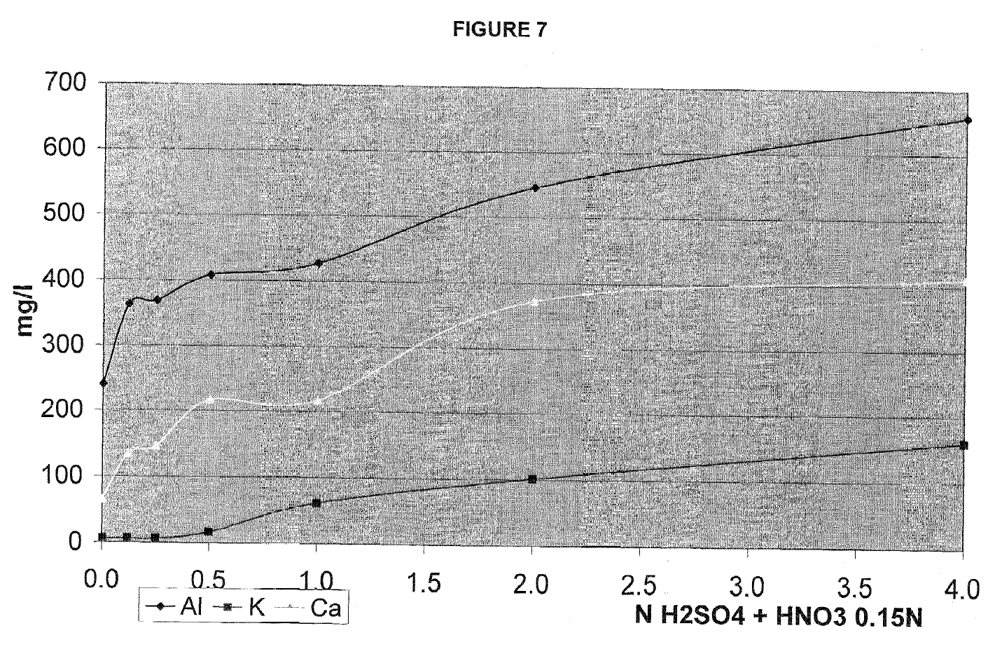

Keeping the concentration of HNO₃ fixed at 0.15 N and varying the concentration of H₂SO₄ from 0.12 to 4 N, series of acidic solutions were prepared. Technical oxide was mixed in each of the solutions and the results of the leaching/oxidation with H₂SO₄/HNO₃ mixtures are summarized in Table 4. The dissolution of MoO₃ in varying concentrations of the acidic solution is shown in FIG. 6. Under these conditions, Ca and K dissolved only when the concentration of H₂SO₄ was greater than 2 N. Al required concentrations greater than 4 N to dissolve. See FIG. 7. Fe and Ca dissolved readily in 0.1 NH₂SO₄.

TABLE 4

| | | | EX. 3A | EX. 3B | EX. 3C | EX. 3D | EX. 3E | EX. 3F | EX. 3G | EX. 3H | EX. 3I | EX. 3J |
|---|---|---|---|---|---|---|---|---|---|---|---|---|
| Intake | intake g | | 75 | 75 | 75 | 75 | 75 | 75 | 75 | 75 | 75 | 75 |
| | liquid ml | | 250 | 250 | 250 | 250 | 250 | 250 | 250 | 250 | 250 | 250 |
| | N H2SO4 | | 0.12 | 0.25 | 0.50 | 1.00 | 2.00 | 4.00 | 4.00 | 4.00 | 2.00 | 2.00 |
| | ml H2SO4 96% | | 0.80 | 1.65 | 3.30 | 6.60 | 13.50 | 27.00 | 27.00 | 27.00 | 13.50 | 13.50 |
| | N HNO3 | | 0.15 | 0.15 | 0.15 | 0.15 | 0.15 | 0.15 | 0.25 | 0.50 | 0.25 | 0.50 |
| | ml HNO3 65% | | 2.60 | 2.60 | 2.60 | 2.60 | 2.60 | 2.60 | 5.20 | 8.70 | 5.20 | 8.70 |
| | solids % | | | | | | | | | | | |
| | leaching temp ° C. | | 70 | 70 | 70 | 70 | 70 | 70 | 70 | 70 | 70 | 70 |
| | leaching time hrs | | 2 | 2 | 2 | 2 | 2 | 2 | 2 | 2 | 2 | 2 |
| filtercake | % MgO | <0.1 | <0.1 | <0.1 | <0.1 | | | | | | | |
| 500° C. | % SiO2 | 5.30 | 4.60 | 4.80 | 4.50 | 4.70 | 5.50 | 4.70 | 6.20 | 6.20 | 5.50 | 5.40 |
| XRF | % K2O | 0.10 | 0.20 | 0.20 | 0.20 | 0.10 | <0.1 | <0.1 | — | <0.1 | <0.1 | 0.10 |
| method | % CaO | 0.30 | 0.20 | 0.20 | 0.20 | 0.20 | 0.10 | <0.1 | <0.1 | <0.1 | 0.10 | <0.1 |
| Uniquant | % Fe2O3 | 0.90 | 0.10 | 0.10 | <0.1 | <0.1 | <0.1 | <0.1 | <0.1 | <0.1 | <0.1 | <0.1 |
| | % MoO3 | 91.70 | 94.30 | 94.20 | 94.50 | 94.40 | 93.70 | 93.30 | 93.10 | 93.10 | 93.70 | 93.90 |
| | % CuO | 0.40 | | | | | | | | | | |
| | % PbO | | | | | | | | | | | |
| | % Na2O | | | | | | | | | | | |
| | % SO4 | | | | | | | 0.50 | | | | |
| filtercake | % MoO2 | 6.53 | 6.59 | 6.32 | 6.99 | 6.68 | 5.30 | 2.60 | <0.1 | 0.20 | 2.90 | 2.60 |
| 120° C. | % MoO3 | 83.15 | 85.95 | 85.54 | 86.04 | 85.64 | 86.44 | 88.14 | 89.70 | 89.30 | 86.10 | 87.50 |
| filtrate ICP | Al | | 363 | 369 | 408 | 427 | 545 | 658 | | | | |
| analyses | Ba | | | | | | | | | | | |
| mg/l | Ca | | 134 | 146 | 216 | 217 | 373 | 411 | 430 | 422 | 430 | 440 |
| | Mg | | 36 | 36 | 38 | 34 | 35 | 33 | 36 | 36 | 38 | 39 |
| | Na | | 16 | 15 | 21 | 28 | 38 | 36 | 37 | 36 | 35 | 36 |
| | P | | | | | | | | | | | |
| | S | | 1745 | 3555 | 7714 | 14245 | 28895 | 57195 | 63930 | 61505 | 28600 | 29320 |
| | Sr | | 13 | 13 | 16 | 14 | 19 | 16 | 20 | 20 | 24 | 25 |
| | Cu | | 714 | 719 | 801 | 743 | 793 | 778 | 859 | 839 | 792 | 793 |
| | Fe | | 1544 | 1549 | 1698 | 1571 | 1652 | 1613 | 1763 | 1739 | 1694 | 1696 |
| | Mo | | 3220 | 3858 | 6271 | 11050 | 22930 | 31810 | 36725 | 32165 | 21780 | 25920 |
| | P | | 28 | 27 | 29 | 24 | 23 | 25 | 28 | 27 | 26 | 25 |
| | Ti | | 1 | 3 | 5 | 14 | 22 | 26 | 24 | 22 | 18 | 20 |
| | Zn | | 17 | 17 | 17 | 16 | 15 | 14 | 15 | 15 | 16 | 17 |
| | K | | 6 | 6 | 16 | 61 | 101 | 119 | 121 | 112 | 91 | 99 |

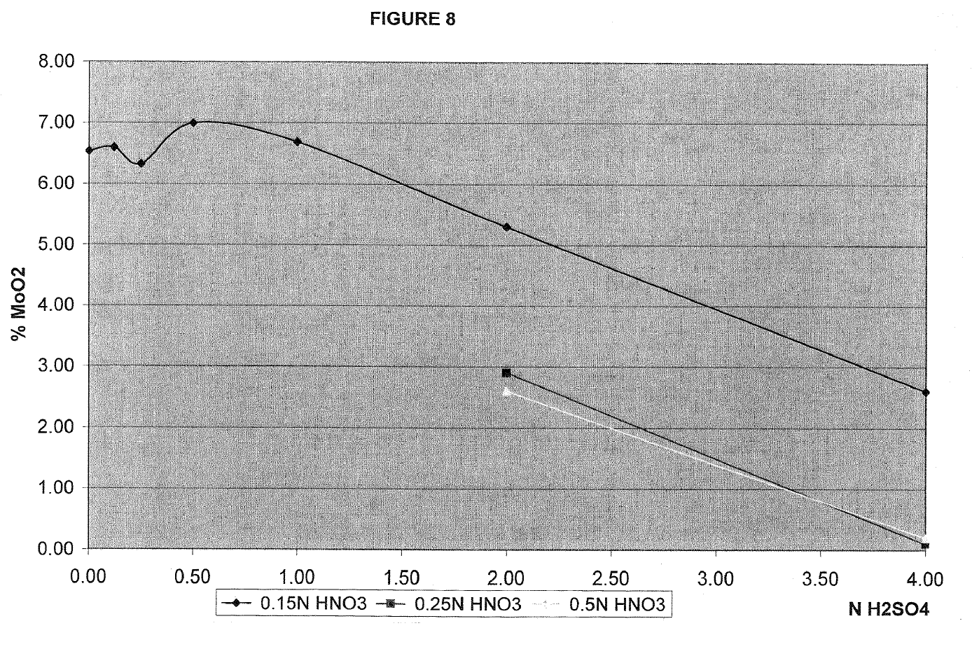

MoO₂ oxidized only when the concentration of H₂SO₄ was greater than 2 N, and the oxidation was not always complete. See FIG. 8. Additional experiments were performed with 0.25 and 0.5 N HNO₃. The results are summarized in FIG. 8 and Table 4.

### Sulfuric Acid/Hydrogen Peroxide:

A series of acidic solutions were prepared with an H₂SO₄ concentration of 4 N and varying concentrations of H₂O₂. The quantity of water was selected such that the total volume of acid, water and hydrogen peroxide equaled 250 ml. Hydrogen peroxide was slowly dropped into the reaction mass to control the vigorous reaction. The oxidation stoichiometry can be summarized as follows:

2H₂O₂→O₂(g)↑+2H₂O

2MoO₂+O₂→2MoO₃

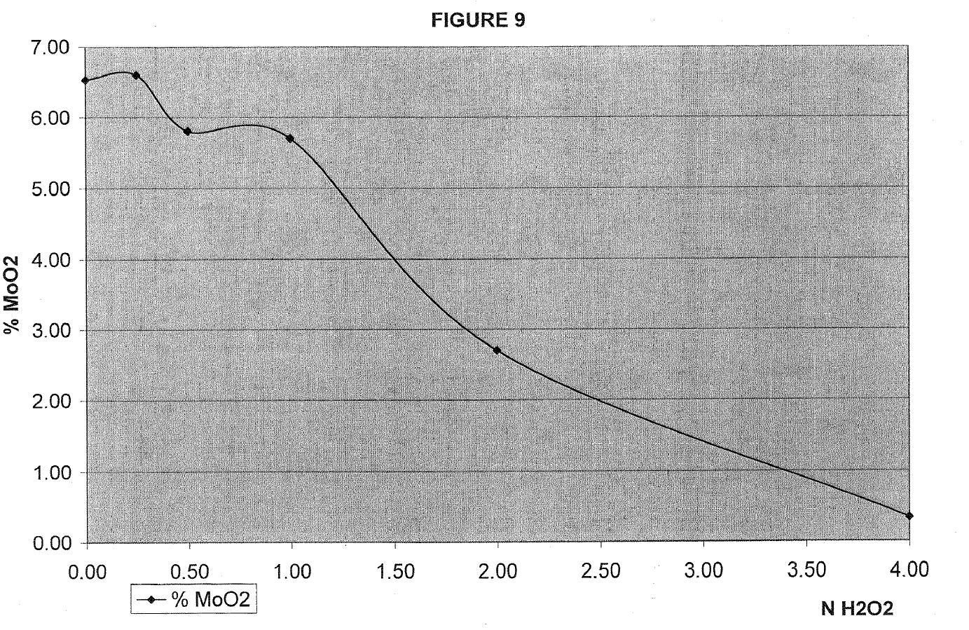

Because oxygen is lost, oxidation proceeds with a low efficiency, thus requiring excess H₂O₂. See FIG. 9. Addition of small amounts of nitric acid did not significantly increase oxidation efficiency. The results of the leaching/oxidation with H₂SO₄/H₂O₂ mixtures are summarized in Table 5.

Peroxide is may also react directly with MoO2 according to the following stoichiometry:

MoO₂+H₂O₂→H₂MoO₄ (dissolved) or to MoO₃+H₂O

followed by crystallization to H₂MoO₄ or other MoO₃ solids. The reaction of MoO₂ with oxygen primarily occurs at autoclave conditions (temperatures above about 200° C.).

| | | EX. 4A | EX. 4B |
|---|---|---|---|
| Intake | intake g | 75 | 75 |
| | liquid ml | 250 | 250 |
| | N H2SO4 | 4N | 4N |
| | ml H2SO4 96% | 28.00 | 28.00 |
| | N H2O2 | 1.00 | 0.25 |
| | ml H2O2 30% | 25.00 | 6.25 |
| | solids % | 22.50 | |
| | leaching temp ° C. | 70 | 70 |
| | leaching time hrs | 2 | 2 |
| filtercake 500° C. | % MgO | | <0.1 |
| XRF method | % SiO2 | | 5.30 |
| Uniquant | % K2O | | <0.1 |
| | % CaO | | <0.1 |
| | % Fe2O3 | | <0.1 |
| | % MoO3 | | 93.80 |
| | % CdO | | |
| | % ThO2 | | |
| | % CuO | | |
| | % PbO | | |
| | % Na2O | | |
| | % SO4 | | 0.20 |
| filtercake 120° C. | % MoO2 | 6.60 | 5.91 |
| | % MoO3 | 82.60 | 85.59 |
| filtrate ICP | Ag | | |
| analyses mg/l | Al | | 532 |
| | Ba | | |
| | Ca | | 400 |
| | Mg | | 32 |
| | Na | | 35 |
| | P | | |
| | S | | 55740 |
| | Sr | | 16 |
| | Cu | | 737 |
| | Fe | | 1521 |
| | Mo | | 24075 |
| | Pb | | 30 |
| | Ti | | 25 |
| | Zn | | 15 |
| | K | | 116 |

### Sulfuric Acid/Potassium Permanganate:

A series of acidic solutions were prepared with an H₂SO₄ concentration of 4 N and varying concentrations of KMnO₄. The oxidation stoichiometry is believed to proceed as follows:

3MoO₂+2MnO₄⁻+2H⁺→3MoO₃+2MnO₂(s)+H₂O

2MnO₂(s)+2MoO₂+4H⁺→2MoO₃+2Mn²⁺+2H₂O

### With excess MnO₄⁻:

3Mn²⁺+2MnO₄⁻+2H₂O→5MnO₂(s)+4H⁺

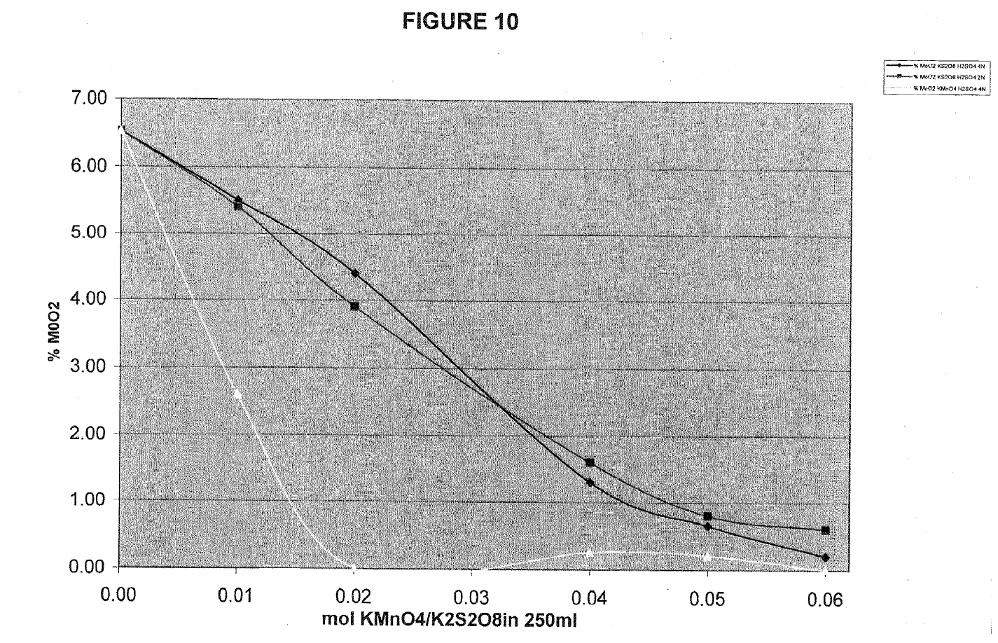

The results of the leaching/oxidation with H₂SO₄/KMnO₄ mixtures are summarized in Table 6 and FIG. 10.

TABLE 6

| | | EX. 5A | EX. 5B | EX. 5C | EX. 5D | EX. 5E | EX. 5F |
|---|---|---|---|---|---|---|---|
| | | KMnO₄ | KMnO₄ | KMnO₄ | KMnO₄ | K₂S₂O₈ | K₂S₂O₈ |
| Intake | intake g | 75 | 75 | 75 | 75 | 75 | 75 |
| | liquid ml | 250 | 250 | 250 | 250 | 250 | 250 |
| | N H2SO4 | 4N | 4N | 4N | 4N | 4N | 4N |
| | ml H2SO4 96% | 28.00 | 28.00 | 28.00 | 28.00 | 28.00 | 28.00 |
| | mol KMnO4/KS2O8 | 0.01 | 0.02 | 0.04 | 0.05 | 0.02 | 0.04 |
| | g KMnO4/g K2S2O8 | 1.55 | 3.10 | 6.25 | 7.90 | 4.60 | 9.20 |
| | solids % | 22.50 | 22.50 | 22.50 | 22.50 | 22.50 | 22.50 |
| | leaching temp ° C. | 70 | 70 | 70 | 70 | 70 | 70 |
| | leaching time hrs | 2 | 2 | 2 | 2 | 2 | 2 |
| filtercake 500° C. | | | | | | | |
| XRF method | % MgO | <0.1 | <0.1 | <0.1 | <0.1 | <0.1 | <0.1 |
| Uniquant | % SiO2 | 5.80 | 5.70 | 5.60 | 4.80 | 5.60 | 6.20 |
| | % K2O | 0.20 | 0.20 | 0.80 | 1.00 | 0.20 | 0.30 |
| | % CaO | — | <0.1 | <0.1 | 0.1 | <0.1 | <0.1 |
| | % Fe2O3 | <0.1 | <0.1 | 0.10 | 0.10 | <0.1 | <0.1 |
| | % MoO3 | 93.40 | 93.40 | 87.80 | 86.60 | 93.60 | 93.00 |
| | % CdO | | | | | | |
| | % ThO2 | | | | | | |
| | % CuO | <0.1 | <0.1 | <0.1 | <0.1 | <0.1 | <0.1 |
| | % PbO | | | | | | |
| | % Na2O | | | | | | |
| | % SO4 | | | 1.10 | 1.70 | | |
| | % MnO2 | <0.1 | <0.1 | 4.00 | 5.20 | | |
| filtercake 120° C. | % MoO2 | 2.60 | <0.1 | 0.25 | 0.21 | 4.40 | 1.30 |
| | % MoO3 | 87.00 | 89.70 | 82.60 | 82.70 | 85.00 | 88.10 |
| filtrate ICP | Al | | | | | | |
| analyses mg/l | Ba | | | | | | |
| | Ca | 445 | 449 | 433 | 432 | 452 | 444 |
| | Mg | 38 | 37 | 37 | 37 | 40 | 39 |
| | Na | 47 | 49 | 57 | 60 | 59 | 70 |
| | S | 64730 | 64580 | 64370 | 63430 | 67900 | 71400 |
| | Sr | 29 | 33 | 35 | 35 | 37 | 40 |
| | Cu | 796 | 795 | 821 | 780 | 817 | 774 |
| | Fe | 1734 | 1736 | 1642 | 1643 | 1711 | 1647 |
| | Mo | 28160 | 34560 | 39255 | 38190 | 29110 | 35950 |
| | P | 33 | 22 | 22 | 22 | 29 | 24 |
| | Ti | 24 | 21 | 21 | 20 | 26 | 26 |
| | Zn | 16 | 15 | 14 | 14 | 16 | 15 |
| | K | 1174 | 1919 | 3493 | 4282 | 3356 | 6742 |
| | Mn | 2120 | 4242 | 98 | 158 | | |

| | | EX. 5G | EX. 5H | EX. 5I | EX. 5J |
|---|---|---|---|---|---|
| | | K₂S₂O₈ | K₂S₂O₈ | K₂S₂O₈ | K₂S₂O₈ |
| Intake | intake g | 75 | 75 | 75 | 75 |
| | liquid ml | 250 | 250 | 250 | 250 |
| | N H2SO4 | 4N | 2N | 2N | 2N |
| | ml H2SO4 96% | 28.00 | 13.50 | 13.50 | 13.50 |
| | mol KMnO4/KS2O8 | 0.06 | 0.02 | 0.04 | 0.06 |
| | g KMnO4/g K2S2O8 | 13.80 | 4.60 | 9.20 | 13.80 |
| | solids % | 22.50 | 22.50 | 22.50 | 22.50 |
| | leaching temp ° C. | 70 | 70 | 70 | 70 |
| | leaching time hrs | 2 | 2 | 2 | 2 |
| filtercake 500° C. | | | | | |
| XRF method | % MgO | <0.1 | <0.1 | <0.1 | <0.1 |
| Uniquant | % SiO2 | 5.90 | 4.40 | 4.60 | 4.70 |
| | % K2O | 0.40 | 0.50 | 0.90 | 1.10 |
| | % CaO | <0.1 | 0.10 | <0.1 | <0.1 |
| | % Fe2O3 | <0.1 | <0.1 | <0.1 | <0.1 |
| | % MoO3 | 93.20 | 94.00 | 93.80 | 92.70 |
| | % CdO | | | | |
| | % ThO2 | | | | |
| | % CuO | <0.1 | <0.1 | <0.1 | <0.1 |
| | % PbO | | | | |
| | % Na2O | | | | |
| | % SO4 | | <0.1 | <0.1 | 0.10 |
| | % MnO2 | | | | |
| filtercake 120° C. | % MoO2 | 0.20 | 3.90 | 1.60 | 0.60 |
| | % MoO3 | 89.10 | 85.70 | 87.40 | 87.90 |
| filtrate ICP | Al | | 371 | 402 | 366 |
| analyses mg/l | Ba | | | | |
| | Ca | 459 | 313 | 393 | 417 |
| | Mg | 40 | 36 | 40 | 37 |
| | Na | 76 | 49 | 57 | 56 |
| | S | 73315 | 33150 | 37045 | 42760 |
| | Sr | 44 | 20 | 21 | 23 |
| | Cu | 770 | 775 | 780 | 755 |
| | Fe | 1632 | 1653 | 1682 | 1635 |
| | Mo | 36890 | 14210 | 12580 | 18165 |
| | P | 24 | | | |
| | Ti | 25 | 18 | 16 | 18 |
| | Zn | 15 | 15 | 14 | 14 |
| | K | 10550 | 3771 | 7999 | 11980 |
| | Mn | | 2 | 2 | 2 |

### Sulfuric Acid/Potassium Persulfate:

A series of acidic solutions were prepared with an H₂SO₄ concentration of 4 N and varying concentrations of KS₂O₈. The oxidation stoichiometry is believed to proceed as follows:

MoO₂+S₂O₈²⁻+H₂O→MoO₃+2SO₄²⁻+2H⁺

### The results of the leaching/oxidation with H₂SO₄/KMnO₄ mixtures are summarized in Table 6 and FIG. 10.

### Caro's Acid:

Caro's acid is produced from concentrated sulfuric acid (usually 96-98%) and concentrated hydrogen peroxide (usually 60-70%), and comprises peroxymonosulfuric acid. Caro's acid is an equilibrium mixture having the following relationship:

H₂O₂+H₂SO₄ [symbol] H₂SO₅+H₂O

The oxidation stoichiometry for MoO₂ in Caro's acid is believed to proceed as follows:

MoO₂+H₂SO₅→MoO₃+H₂SO₄

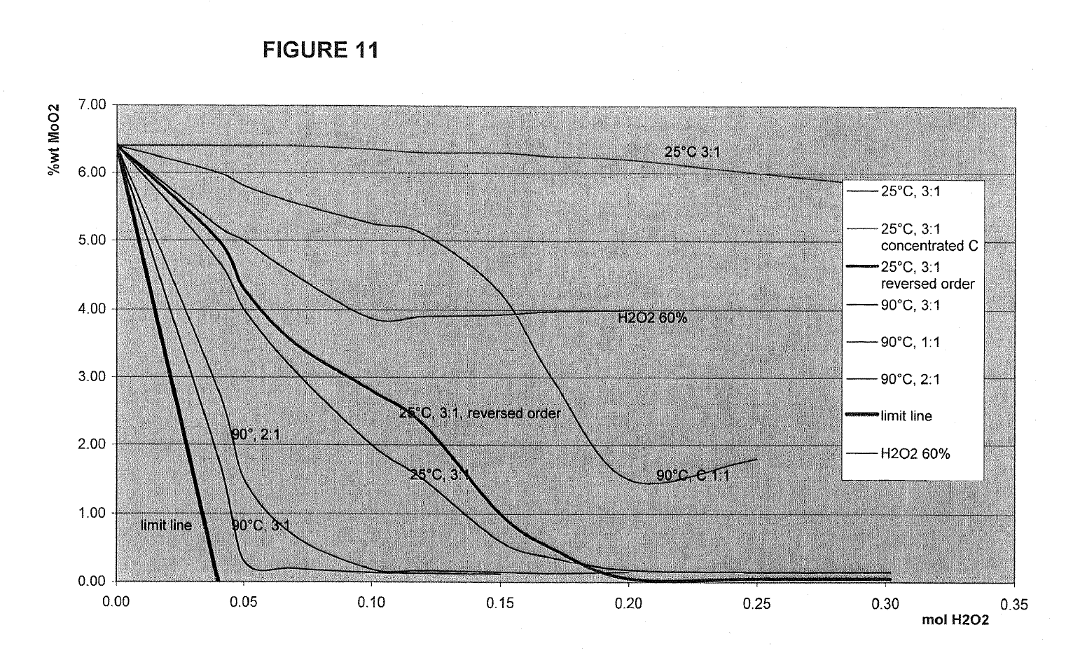

75 grams of technical oxide was mixed with water and Caro's acid (H₂SO₄:H₂O₂=3:1, 2:1, and 1:1). In some embodiments, higher ratios may also be employed, such as 4:1 and 5:1. In separate experiments, the temperature of the reaction mass was either cooled or heated to T=25, 70 and 90° C. for and mixed for two hours. The results of the leaching/oxidation with Caro's acid mixtures are summarized in FIG. 11.

### Chlorine, Chlorinated Compounds and Bromine:

A three-necked jacketed 250 mL creased flask was used as the reactor. It was fitted with a ⅛″ Teflon feed tube (dip-tube) for chlorine addition, a condenser, a thermometer and a pH meter. The top of the condenser was connected with a T joint to a rubber bulb (as a pressure indicator) and to a caustic scrubber through a stop-cock and a knock-out pot. The flask was set on a magnetic stirrer. The jacket of the flask was connected to a circulating bath. Chlorine was fed from a lecture bottle set on a balance and a flow meter was used for controlling the chlorine feed. The lecture bottle was weighed before and after each experiment to determine the amount of chlorine charged.

Technical oxide (50 g) was suspended in 95 g of water and/or recycled molybdenum solution from the ion-exchange step of previous experiments. Concentrated sulfuric acid was added in drops to bring the pH of the reaction mass down to 0.2 and the suspension was magnetically stirred. The suspension was heated to 60° C. using the circulating bath and stirred at that temperature for about 30 minutes. Chlorine was fed using a flow meter and bubbled through the suspension. The reaction was exothermic as indicated by the temperature increase to about 62° C. Chlorine feed was stopped when there was no more consumption of Cl₂ as indicated by an increase in pressure and drop in temperature to about 60° C. Stirring of the reaction mixture at 60° C. under slight chlorine pressure was continued for an hour to ensure complete oxidation. Nitrogen or air was then bubbled for 30 minutes to strip off unreacted chlorine. A 20% solution of NaOH was carefully added in drops to bring the pH up to 0.2. After pH adjustment, the mixture was stirred at 60° C. for an hour. It was then cooled to 30° C. and filtered using a fritted funnel (M) under suction. The solid on the funnel was washed with 25 g of 5% sulfuric acid and then with 25 g of water. The wet cake was weighed and then dried in an oven at 95° C. for about 15 hours. The filtrate was analyzed by ICP for molybdenum and other metals. The dried solid was analyzed by ICP for metal impurities. Some of the solid samples were also analyzed for the amount of MoO₂ and MoO₃.

### Oxidation with Chlorine:

### Example 1

A 20 g sample of the technical oxide was suspended in 60 g of water. Concentrated sulfuric acid (10 g) was added and the mixture was heated to 60° C. After stirring the mixture for 30 minutes at 60° C., chlorine (3.6 g) was slowly bubbled through the mixture over a period of 40 minutes. The gray slurry became light green. The mixture was heated to 90° C. and stirred at 90° C. for 30 minutes. Nitrogen was bubbled through the mixture at 90° C. for 30 minutes to strip off any unreacted chlorine. The mixture was cooled to room temperature. The slurry was then filtered under suction and washed with 20 g of 2% hydrochloric acid and 20 g of water. The wet cake (22.6 g) was dried in an oven at 90° C. for 15 hours to yield 16.8 g of product.

Analysis of Starting Tech. Oxide and Product by ICP:

| | MoO₃ | MoO₂ | Fe | Cu | Al |
|---|---|---|---|---|---|
| | (wt %) | (wt %) | (ppm) | (ppm) | (ppm) |
| Starting Tech. Oxide | 70.8 | 13.9 | 13400 | 15200 | 3110 |
| Product | 90.6 | 0.05 | 457 | 200 | 233 |

### Example 2

A slurry of 50 g of the same technical oxide used in Example 1 was formed in 95 g of water was stirred at 60° C. for 30 minutes. Chlorine (6.8 g) was bubbled through the slurry for about 40 minutes, maintaining a positive pressure of chlorine in the reactor. The slurry changed from gray to pale green. Nitrogen was bubbled for 30 minutes to strip off excess chlorine. Concentrated HNO₃ (5.0 g) was added dropwise to the mixture at 60° C. and stirred at 60° C. for 30 minutes after the addition. Then 20% NaOH solution was added to adjust the pH to 0.5. The mixture was cooled to 25° C. and filtered under suction. The wet cake (62.3 g) was dried in an oven at 90° C. for 16 hours to get 49.5 g of product. ICP analysis of the oxidized product showed that it contained 502 ppm Fe, 58 ppm Cu and 15 ppm Al.

| | Fe | Cu | Al |
|---|---|---|---|
| | (ppm) | (ppm) | (ppm) |
| Starting Tech. Oxide | 13400 | 15200 | 3110 |
| Product | 502 | 58 | 15 |

### Example 3

Concentrated HCl (8.8 g) was added to a slurry of technical oxide (from a different source as compared to Examples 1 and 2) in 150 g of water to adjust the pH of the mixture to 0.4. The mixture was heated to 60° C. and stirred at that temperature for 30 minutes. Chlorine was slowly bubbled through the mixture till there was a positive pressure of chlorine in the reactor. It took 1.4 g of chlorine over a period of 35 minutes. The mixture was stirred at 60° C. for 30 minutes after chlorine addition and then nitrogen was bubbled through the mixture for 30 minutes. The liquid phase of the slurry had a pH of 0.4. The slurry was then cooled to room temperature and filtered under suction. The solid was washed with 25 g of 5 wt % HCl and 25 g of water. The wet cake (55.0 g) was dried in an oven at 90° C. for 16 hours to get 47.4 g of product.

### Analysis of Starting Technical Oxide and Product by ICP:

| | MoO₃ | MoO₂ | Fe | Cu | Al |
|---|---|---|---|---|---|
| | (wt %) | (wt %) | (ppm) | (ppm) | (ppm) |
| Starting Tech. Oxide | 90.8 | 4.30 | 7270 | 1700 | 1520 |
| Product | 97.07 | 0.03 | 526 | 29 | 37 |

### Oxidation with Sodium Hypochlorite:

Technical oxide (20 g) was added to 45 g of water and 5 g of concentrated sulfuric acid taken in a jacketed 100 mL flask. The mixture was heated to 60° C. and magnetically stirred at that temperature for 30 minutes. Sodium hypochlorite solution (20 g) containing 10-13% active chlorine was taken in an addition funnel and added dropwise over 30 minutes. Color of the sorry changed from gray to blue to light green indicating complete oxidation. The liquid portion of the slurry had a pH of 0 as shown by pH paper. The mixture was cooled to room temperature and filtered under suction. The solid on the funnel was washed with 20 g of 5 wt % sulfuric acid and 20 g of water. The wet product (22.4 g) was dried in an oven at 90° C. for 16 hours to get 18.3 g of product.

ICP analysis of Tech. Oxide and Product:

| | MoO₃ | MoO₂ | Fe | Cu | Al |
|---|---|---|---|---|---|
| | (wt %) | (wt %) | (ppm) | (ppm) | (ppm) |
| Starting Tech. Oxide | 70.8 | 13.9 | 13400 | 15200 | 3110 |
| Product | 91.2 | 0.05 | 520 | 180 | 54 |

### Oxidation with Bromine:

A slurry of the same technical oxide from Examples 1 and 2 (40 g) in 120 g of water was taken in a 250 mL jacketed flask and stirred at 60° C. for 30 minutes. Bromine (10 g) taken in an addition funnel was slowly added in drops. Disappearance of the red color of bromine indicated reaction. Bromine addition took about 30 minutes. The mixture was heated to 90° C. and stirred at 90° C. for 30 minutes. Nitrogen was bubbled through the mixture at 90° C. for 30 minutes to strip off unreacted bromine. The mixture was cooled to room temperature and filtered under suction. The solid was washed with 20 g of 2 wt % HCl and 20 g of water. The wet cake (60.4 g) was dried at 90° C. for 16 hours to 38.6 g of product. The oxidized product had about 5000 ppm Fe, 600 ppm Cu and 200 ppm Al.

| | MoO₃ | MoO₂ | Fe | Cu | Al |
|---|---|---|---|---|---|
| | (Wt %) | (Wt %) | (ppm) | (ppm) | (ppm) |
| Tech. Oxide | 70.8 | 13.9 | 13400 | 15200 | 3110 |
| Product | 87.12 | 0.10 | 5000 | 600 | 200 |

### Oxidation with Sodium Chlorate:

Technical oxide (50 g) was mixed with 80 g of water and 5 g of concentrated sulfuric acid in a 250 mL jacketed flask and stirred at 60° C. for 30 minutes. Sodium chlorate (3 g) was dissolved in 15 g of water and the solution was taken in an addition funnel. The chlorate solution was slowly added in drops to the technical oxide slurry at 60° C. and the addition took about 30 minutes. Change in color of the slurry to light green indicated complete oxidation. The slurry was cooled to room temperature and filtered under suction. The solid was washed with 25 g of 2 wt % sulfuric acid and 25 g of water. The wet cake (65.4 g) was dried in an oven at 90° C. for 16 hours. Product (48.2 g) was analyzed by ICP for metallic impurities.

| | MoO₃ | MoO₂ | Fe | Cu | Al |
|---|---|---|---|---|---|
| | (Wt %) | (Wt %) | (ppm) | (ppm) | (ppm) |
| Tech. Oxide | 70.8 | 13.9 | 13400 | 15200 | 3110 |
| Product | 85.80 | 0.64 | 2435 | 639 | 113 |

While the compositions and methods of this invention have been described in terms of distinct embodiments, it will be apparent to those of skill in the art that variations may be applied to the compositions, methods and/or processes and in the steps or in the sequence of steps of the methods described herein without departing from the concept and scope of the invention. More specifically, it will be apparent that certain agents, which are chemically related, may be substituted for the agents described herein while the same or similar results would be achieved. All such similar substitutes and modifications apparent to those skilled in the art are deemed to be within the scope and concept of the invention.

1. A process for converting molybdenum sulfide raw materials into a purified molybdenum trioxide product comprising the steps of:
a. converting at least a portion of the molybdenum sulfide raw material into a molybdenum oxide product comprising MoO₂, metal impurities and unconverted MoS₂;
b. forming a reaction mass by combining the molybdenum oxide product with an effective amount of at least one leaching agent to leach the metal impurities and an effective amount of at least one oxidizing agent to oxidize MoS₂ to MoO₂ or MoO₃, and MoO₂ to MoO₃; and
c. separating the reaction mass into a solid purified molybdenum trioxide product and a residual impurity-containing liquid.

2. The process of claim 1, further comprising the step of recovering at least a portion of any dissolved molybdenum from the residual liquid and recycling the recovered molybdenum to the reaction mass.

3. The process of claim 1, wherein the molybdenum sulfide raw material is derived from a roasting operation.

4. The process of claim 4, wherein the roasting operation is performed under conditions such that only a portion of the molybdenum sulfide is converted to MoO₂ and MoO₃.

5. The process of claim 2, wherein the leaching agent is sulfuric acid, hydrochloric acid, nitric acid, hydrobromic acid, or mixtures thereof.

6. The process of claim 5, wherein the oxidizing agent is chlorine, bromine, hydrogen peroxide, or mixtures thereof.

7. The process of claim 1, wherein the reaction mass is heated to a temperature in the range of about 30 the about 150° C.

8. The process of claim 1, wherein the reaction mass is agitated for about 15 minutes to about 24 hours.

9. The process of claim 2, wherein a single substance both leaches metal impurities and oxidizes MoO₂ to MoO₃.

10. The process of claim 9, wherein the single substance is Caro's acid having a H₂SO₄ to H₂O₂ ratio ranging from about 1:1 to 5:1.

11. The process of claim 2, wherein the addition of oxidizing agent to the reaction mass results in the in situ formation of the leaching agent.

12. The process of claim 11, wherein the oxidizing agent is chlorine, bromine or mixtures thereof.

13. The process of claim 12, wherein the reaction mass is heated to a temperature in the range of about 30 the about 150° C.

14. The process of claim 13, wherein the reaction mass is agitated for about 15 minutes to about 24 hours.

15. The process of claim 2, wherein the at least a portion of any dissolved molybdenum is recovered by ion exchange.

16. A solid purified molybdenum trioxide prepared in accordance with the process of claim 1.
